(19) United States
(12) Patent Application Publication
(10) Pub. No.: US 2004/0077497 A1
(43) Pub. Date: Apr. 22, 2004

(54) Dry erase surface

(75) Inventors: Richard J. Korane, Centerville, OH (US); Donald L. Hart, Beavercreek, OH (US)

Correspondence Address: Randy J. Pritzker, Wolf, Greenfield & Sacks, P.C., 600 Atlantic Avenue, Boston, MA, 02210, US

(73) Assignee: Troy Laminating & Coating, Inc., Troy, OH

(21) Appl. No.: 10/629,349

(22) Filed: Jul. 28, 2003

Related U.S. Application Data
(60) Provisional application No. 60/399,848, filed on Jul. 31, 2002.

(51) Int. Cl. B41M 5/20

(52) U.S. Cl. 503/201

(57) ABSTRACT

Dry-erase surfaces and methods of production and use are provided. Improved dry-erase surfaces may be produced from heat-cured resins. Existing dry-erase surfaces such as white boards may be altered or repaired with sheets of dry-erase material.

### RELATED APPLICATION

This application claims the benefit under 35 U.S.C. §119(e) of U.S. Provisional Application No. 60/399,848 filed Jul. 31, 2002, entitled “DRY ERASE SURFACE,” by Richard J. Korane et al. (Attorney's Docket Number T00520.70000). The entirety of the aforementioned application is hereby incorporated by reference.

### FIELD OF THE INVENTION

The invention relates generally to dry-erase surfaces and more particularly to improved dry-erase surfaces and new uses thereof.

### BACKGROUND OF INVENTION

Surfaces that can be written upon with ink markers and easily erased have become popular replacements, or supplements, to chalkboards. These synthetic surfaces, often referred to as “white boards,” are inexpensive to produce and are light in weight, making them easy to install in numerous locations. Typically, an erasable marker is used in conjunction with these boards allowing the writing to be removed with a dry eraser. The surfaces are white and typically are composed of, for example, melamine. They provide good contrast with dark colored markers and are usually easy to erase, when the writing is removed soon after application.

Despite advances in white board manufacture, there are a number of problems that can develop with these products, particularly with age. For example, after they are written upon, white boards often exhibit “ghosting”, i.e. a residual image of previously written material that remains after the writing is dry-erased. Treatment with solvents can help, but is cumbersome and cannot always remove the images completely. These boards may also wear after extended use, resulting in a rough appearance and increased difficulty in erasing material from the white board. Many white boards employ glossy surfaces that can aid in the removal of a variety of inks from the surface. However, some ghosting may still occur and these highly reflective surfaces can exhibit undesirable glare.

Recent advancements in the production of dry-erase surfaces have provided materials for improving white boards and white board materials. For example, U.S. Pat. No. 5,037,702 discloses the use of UV and EB curable urethane acrylates to provide a coating having improved characteristics for write-on/wipe-off applications. Similarly, U.S. Pat. No. 6,265,074 discloses the use of cross-linked epoxy polymers that demonstrate good solvent-resistance and may be applied to suitable substrates, such as paper or film, and then laminated to a rigid support such as foam board, to produce write-erase surfaces.

### SUMMARY OF THE INVENTION

In one aspect, a method of repairing a dry-erase surface is provided, the method comprising providing a sheet comprising two sides, a first side comprising a dry-erase material and a second side comprising an adhesive, and adhering the sheet to the dry-erase support.

In another aspect, a method of transforming a writing surface into a dry-erase surface is provided, the method comprising providing a sheet having at least two sides, a first side comprising a dry-erase surface having a surface tension greater than 30 dynes/cm and a second side comprising an adhesive, and adhering the sheet to the writing surface.

In another aspect, a dry-erase surface is provided, the dry-erase surface comprising a substrate, and a heat cured resin disposed on the substrate to form the dry-erase surface wherein the dry-erase surface exhibits a surface tension of greater than 30 dynes/cm.

In another aspect, a dry-erase surface is provided, the dry-erase surface comprising a substrate and a heat cured resin disposed on a portion of the substrate to form the dry-erase surface wherein the surface exhibits a 60° gloss of less than about 90 gloss units.

In another aspect, an article is provided, the article comprising a plurality of sheets stacked substantially overlapped, at least two of the sheets each comprising a first surface and a second surface wherein the first surface comprises a dry-erase surface and the second surface comprises a removable adhesive wherein the second surface of a first sheet is in contact with the first surface of a second sheet.

In another aspect, a method is provided, the method comprising writing on a first sheet of a stack of a plurality of sheets wherein the first sheet and a second sheet each comprise a first surface and a second surface, the first surface comprising a dry-erase coating and the second surface comprising a removable adhesive, removing the first sheet from the stack, adhering the first sheet to a substrate, and writing on the second sheet.

In another aspect, a kit is provided, the kit comprising a first dry-erase surface comprising a dry-erase coating disposed on a substrate, and instructions for affixing the first dry-erase surface to a second dry-erase surface.

Other aspects, embodiments, and features of the invention will become apparent from the following detailed description. All references incorporated herein are incorporated in their entirety. In cases of conflict between an incorporated reference and the present specification, the present specification shall control.

### DETAILED DESCRIPTION

The invention provides for a dry-erase surface that can be used in a number of applications, including, white boards, repair of white boards and other dry-erase surfaces, and the use of these surfaces in new applications. A dry-erase surface is defined herein as a surface that can be repeatedly written upon with colored, solvent-based ink markers or “lowodor” ink markers, or water-based markers, and from which the resultant writing can be “dryerased,” i.e., erased without the use of solvents. A “completely erasable” dry-erase surface is a dry-erase surface that retains no residue (ghosting) detectable by the unaided eye. A “writable surface” is a surface that is typically written on but from which erasable inks are not easily removed. Examples of writable surfaces include paper, cardboard, and chalkboards.

To prevent ghosting, inks that are deposited on the surface of dry-erase materials should not be absorbed into the material. Nonetheless, the surface should be able to retain and hold the ink for an extended period of time. Thus, a compromise is typically struck between erasability and legibility of the writing. The type of marker being used can alter this balance for any particular surface, making the writing either difficult to read or difficult to erase. The particular solvent used in the marker may be one factor that affects marker performance. Dry-erase inks may be based on ketones, aromatic hydrocarbons, alcohols, glycols or mineral spirits, for examples.

In one aspect, a heat cured polymeric material can provide a superior dry-erase surface. For example, the material may resist ghosting, may resist wear and/or resist the effects of chemicals, such as the solvents typically used with write on/wipe off markers. These solvents include, for examples, alcohols and ketones. The heat-cured polymeric material may exhibit low gloss, resulting in a write on/wipe off surface with a more agreeable, less reflective writing background.

In one embodiment, a variety of polymer resins may be heat-cured to provide improved performance in dry-erase applications. These polymer formulations can result in reduced ghosting, improved solvent-resistance, increased surface tension, lower gloss, or any combination of these attributes. Polymeric materials that can be used to produce an effective dry-erase surface include, for examples, alkyd, acrylic or polyester resins, or mixtures thereof, such as alkyd/acrylic, alkyd/polyester, acrylic/polyester or alkyd/acrylic/polyester mixtures.

The polymeric resins can be dissolved or diluted in an organic solvent or solvent system so that a polymer coating, or layer, can be formed. The solvent system can provide a low viscosity, pre-polymer solution that is capable of dissolving or dispersing additional materials such as cross-linkers, catalysts and fillers. The solvents may be polar, non-polar, or mixtures thereof. The solvents may also be volatile to facilitate drying of the polymer coating. These solvents may consist of, for examples, aromatic hydrocarbons and/or alcohols. Some specific solvent examples include toluene, xylene, ethyl benzene, propanol, isopropyl, butanol and isobutanol. In one embodiment, a combination of toluene and isobutanol is used to form the pre-polymer solution.

Catalysts can be added to the polymer solution to promote cross-linking and/or chain polymerization. Acid catalyzed systems using strong organic acids, such as toluene sulfonic acid, have been shown to provide good catalytic activity.

A cross-linking compound can be added to the polymer solution to promote a resilient surface that is solvent-resistant and durable. The cross-linking compound should be compatible with the polymer system and preferably results in a durable surface that resists ghosting and attack by solvents. Cross-linking agents include, for example, amino resins. One such cross-linker is methylated melamine resin.

Although other polymerization techniques can been used, heat-curing of the formulations described herein has been shown to provide dry-erase coatings that exhibit excellent dry-erase attributes, such as, solvent-resistance, wear-resistance, ghosting-resistance and/or low or semi-gloss surface appearance.

The dry-erase coatings can be manufactured and applied using methods known to those skilled in the art. The pre-polymer resin or resins can first be dissolved in a solvent to produce a low viscosity solution. Preferably, the viscosity of the solution is from 50-150 centipoise. Additional materials such as cross-linkers, fillers, matting agents, UV inhibitors, flow agents and flatting agents may be added to the solution. One or more catalysts can be added later to initiate the polymerization and cross-linking process. The solution can be premixed and stored or shipped, as the components may be stable prior to the addition of a catalyst. Finally, the solution can be disposed on a substrate and thermally-cured at a temperature of from 200 to 600° F. Preferably, the temperature is from about 400 to about 500° F.

Coatings can be disposed on substrates using a variety of methods known to those skilled in the art. For instance, coatings can be applied at room or elevated temperature by methods such as gravure coating, reverse gravure coating, reverse roll coating, Mayer rod coating or by slot die. Coatings can be applied at a thickness of less than 10 mils, less than 1 mil, and typically greater than about 0.1 or 0.2 mil. As is recognized by those skilled in the art, coating weight is often measured in units of lbs of coating/3,000 ft² of substrate (lbs/3MSF). The coatings can be applied over the range of, for examples, 2 to 8 lbs/3MSF or 4 to 6 lbs/3MSF.

The coatings may be disposed on a number of substrates, and it is preferred that the substrates be flexible. The substrate can be made from a synthetic material such as a polymer film, or a natural material, such as a cellulose-based material like paper or cloth. The substrate may be opaque, transparent, or translucent and can include pigments or dyes to apply color or tints to the substrate. Some examples of substrates that can be used include polyester film, such as acrylic-treated polyester film, vinyl, and polyethylene. Appropriate paper products include clay-coated paper, kraft paper, and paperboard. The substrates may be chosen for specific properties affecting end use such as compatibility with a coating, flexibility, durability, color, opacity, or price.

The substrate coated with the dry-erase surface may also include an adhesive, typically on the side of the substrate opposite to that of the dry-erase coating. The adhesive may be permanent, removable, or repositionable. Removable adhesives should allow the dry-erase material to be applied to a surface and removed without transferring adhesive to the surface, such as a painted wall or a chalkboard. Removable adhesives include microsphere adhesives, such as acrylic emulsion microsphere adhesives. Permanent adhesives, those designed not to be removed, may include acrylic copolymer emulsions and/or vinyl acrylic copolymer emulsions.

Preferably, removable and repositionable adhesives do not transfer adhesive to the surfaces on which the coated substrate may be placed. For example, if the coated substrate is placed on glass or on a painted wall, it is preferred that when the coated substrate is removed, little or no adhesive remains on the wall or glass, thus allowing use of the product on a variety of surfaces without a concern of damaging the surface. Alternatively, a removable adhesive that can be easily cleaned off the underlying surface may also be used. Applications that use a transparent substrate and dry-erase coating preferably make use of adhesives that are also transparent, or otherwise unobtrusive, to the eye. This can facilitate viewing of underlying images on the surface.

Adhesives can be chosen to retain adhesion to a surface of choice under a variety of conditions, such as varying temperature, humidity, extended time periods, and/or the shear forces that may be applied when the dry-erase surface is being written upon or erased. It is preferable that use of a removable or repositionable adhesive, upon removal or repositioning, result in little or no adhesive transfer to a surface upon which the dry-erase coated substrate is applied, while still retaining excellent adhesion to the surface.

Adhesive or adhesives may be applied to a surface of the dry-erase sheet in methods similar to those used to apply the dry-erase coating. For example, the adhesive may be applied by gravure or reverse gravure coating or by Mayer rod. The adhesive may either be applied directly to the surface of the dry-erase sheet or may be applied to a backing such as silicone paper and then transferred to the back of the dry-erase sheet after the two materials are placed together. It is preferred that low tack adhesives are applied directly to the surface of the dry-erase sheet to assure that the adhesive does not remain on a backing, if a backing is used.

The surface tension of a dry-erase coating relates to the surface's ability to “wet out” when written upon with an erasable marker. When the surface tension of a surface is too low, ink may not be adequately transferred from the marker to the surface and, when transferred, the ink may bead up, resulting in a splotchy, incomplete image on the writing surface. If a specific type of marker is to be used with a dry-erase surface, then the surface tension of the coating may be chosen to provide for adequate wetting out for that marker. A dry-erase coating can exhibit a surface tension that makes it universally compatible with most or all commercially available erasable markers. It has been found that a surface tension of about 30 dynes/cm or greater provides an acceptable surface for writing with commercially available markers based on solvents such as alcohols, xylenes and MEK. Specific coatings disclosed herein can exhibit a surface tension of greater than 30, greater than 32, greater than 35, or greater than about 40 dynes/cm.

Dry-erase surfaces may also be evaluated by their “flatness” or their ability to reduce reflection and glare. Commercially available dry-erase surfaces are typically glossier than the backgrounds upon which they are used, such as, for examples, walls painted with flat wall paint, or most wallpapers or blackboards. When observed at 90° to the surface, reflection may not present as great a problem as when viewed from a more obtuse angle. Reflection is also variable with the light under which the dry-erase surface is being viewed. The present invention may take advantage of flatting agents, such as, for example, amorphous precipitated silica. These flatting agents can be added to the coating formulation in amounts greater than 0.5%, 1%, 2%, or 3%, by weight. Upon heat curing, the coating may exhibit a 600 gloss reading of 90, less than 90, less than 80, less than 70, less than 60, or less than 50 gloss units. The “60° gloss test” is a method known to those skilled in the art and provides an objective measure of the glossiness of a surface. The non-glare appearance of the lower range of gloss readings has been shown to provide a more pleasant surface from which to read and allows for comfortable viewing from a greater number of angles under a greater variety of lighting conditions. Furthermore, while existing matte finishes typically adversely affect the writability characteristics of a dry-erase surface, the coatings of the present invention can provide for a low gloss surface that is smooth on which to write, possesses adequate surface tension for smoothly receiving erasable inks, is durable, and resists ghosting, even after writing remains on the surface for a number of months. Coatings exhibiting a surface tension of greater than 30 dynes/cm and a 60° gloss test reading of greater than about 60 gloss units are preferred. Coatings of this type that also pass the “200 MEK double rub test” are most preferred. The 200 MEK double rub test is a surface evaluation method known to those skilled in the art that includes repeatedly rubbing a single portion of a surface 200 times with a wetted cheese cloth that has been dipped in MEK. This provides a measure of the chemical resistance of the surface and provides an indication that the dry erase ink will not stain the surface.

In another aspect, dry-erase surfaces can be used to improve or repair a previously used dry-erase surface. A white board that might have previously been disposed of can be repaired to a condition superior to its condition when new, at far lower effort and cost than replacing the dry-erase board entirely. For example, if a white board exhibits excessive ghosting, wear, or gloss, for instance, a sheet coated with a dry-erase surface can be permanently or temporarily applied over the damaged dry-erase surface. If a rectangular board is to be repaired, a rectangular piece of new dry-erase coated material can be cut or formed to fit over a portion, most of, or all of the previously used surface. The dry-erase material can be one of the coatings disclosed herein, but any suitable dry-erase material can be used. After repair, the damage to the board may no longer be visible, and the dry-erase characteristics of the board can be renewed, changed or improved.

Replacement sheets can be supplied to the end user pre-cut and ready to be placed on a particular used surface or, alternatively, can be supplied to the end user in bulk, such as in a roll, and can be cut to shape by the end user before being applied to the damaged dry-erase surface. The replacement sheet may include a removable, repositionable, or permanent adhesive, or an adhesive can be applied separately by the end user at the time the dry-erase board is repaired. The replacement sheet may also include a releasable backing such as a silicone-coated paper that can be removed to expose an underlying adhesive.

When being placed over a previously existing writable surface, the dry-erase sheet may be colorless and transparent so that the original color of the writing surface shows through, or, alternatively, the new dry-erase surface may be colored and/or opaque to provide a new look to the surface. For example, a wall or chalkboard may retain the characteristics of a green or black background or may be altered to take on the appearance of a white board.

Replacement sheets can also be used with existing dry-erase surfaces to change the appearance of the surface, even if the surface is not damaged. In this manner, a dry-erase board can be customized to match the decor of the room in which it is used. Surfaces of different colors or gloss levels can be affixed to an existing dry-erase surface to alter the characteristics of the surface. The new surface can also include permanent indicia. For example, headings, calendars, grids, graphs, or company logos can be permanently preprinted or embossed on the new surface. Permanent inks such as offset, flexographic, or permanent markers such as MARKS.A.LOT® (Avery-Denison) or SHARPIE® (Sanford) markers may be useful for this purpose.

In another aspect, a dry-erase sheet may be placed over a writable surface that is not a traditional dry-erase surface. For example, a dry-erase sheet may be place over a preprinted sheet of paper, cardboard, plastic, or over a chalkboard. The dry-erase sheet may be transparent so that the underlying surface can be observed through the sheet or may be opaque in order to provide a different look to the surface. In either case, the dry-erase surface may be colored or tinted in order to apply either a colored background or a colored tint to the surface.

In one embodiment, the dry-erase sheet may be tinted with a particular color that can be used to filter out writing or printing of the same or similar color from the dry-erase sheet. In this manner, by applying a differently tinted dry-erase sheet to a common surface, a different set of underlying printing may be allowed to show through the dry-erase sheet and be acted upon by a person using the material. For example, a calendar printed with a schedule in a particular color may have this schedule obscured by overlaying a dry-erase sheet of a specific tint having the same or a similar color. Thus, a particular sheet or document, such as a calendar, may be printed with two sets of information, either one of which may be obscured by the overlay of a properly tinted dry-erase sheet. The second set of information will still be readily visible through the sheet and can be used to convey information to a user.

When used on a paper substrate, such as a calendar or schedule, a temporary or reusable adhesive may be employed with the dry-erase sheet so that the sheet can be removed from the paper substrate without damaging it. In this way, a removable write-on/wipe-off sheet can be transferred from one substrate to a different substrate, thus transferring the information recorded on the dry-erase sheet from one place to another. For example, a work schedule may be written on a dry-erase sheet affixed to a calendar substrate and then the dry-erase sheet may be removed and placed on a different calendar substrate in a different room.

In classrooms, conference rooms or other areas that contain permanent chalkboards, the overlay of a dry-erase surface on the chalkboard may be preferred to the original surface, particularly by those with chalk dust allergies or other concerns about writing with, and erasing, chalk. In one embodiment, a chalkboard may be covered with a dry-erase surface exhibiting a low gloss so that the new dry-erase surface can exhibit a flatter finish that is similar to that of a chalkboard. For example, the gloss may be<90, <80, <70 or <60 gloss units for a 60° gloss test. The dry-erase surface can be applied to the chalkboard using a temporary, repositionable or permanent adhesive and may be supplied in rolls so that chalkboards covering large areas can be retrofitted seamlessly. The dry-erase surface can also be of a color to match the original color of the chalkboard. If a dark color, such as black or green, is used, then it may be preferred that light colored dry-erase markers, such as white or yellow, be used with the surface.

In another embodiment, an underlying surface is provided with a series of dry-erase sheets stacked on top of one another, providing two or more dry-erase sheets, substantially or completely overlapping one another, and forming a stack. The underlying surface can be, for examples, a first dry-erase sheet, a chalkboard, a sheet of paper, or a piece of cardboard. Using this stack, the first sheet on the top of the stack can be removed and adhered to a separate surface, such as a wall or chalkboard. The first sheet may be written upon either before or after removing it from the stack. Upon removal, a second dry-erase sheet may be available at the top of the stack and can then be written upon and either left in place or also removed from the stack and placed on a separate surface. Each sheet, or a plurality of the sheets, may include a dry-erase coating on one side and an adhesive on the opposite side, typically a removable adhesive that preferably does not transfer adhesive to the adjacent dry-erase sheet. The adhesive may cover a portion or the entire side of the sheet. In another embodiment, a release liner, such as silicone coated paper, may be placed between each of the sheets in order to minimize or eliminate the transfer of adhesive to the dry-erase coating of an underlying dry-erase sheet. After one or more sheets has been removed from the stack and adhered to a surface, such as a vertical surface, e.g., a wall, the sheet can be replaced on the stack after being removed from the surface. Any writing on the dry-erase surface can be erased either before or after the sheet is returned to the stack. The stack or a portion of the stack may then be reused in the same or a different location. One or more sheets may be retained separately from the stack in order to retain particular written information. The information on a sheet may be photocopied, scanned or otherwise recorded prior to erasing or replacing the sheet.

The function and advantage of these and other embodiments of the present invention will be more fully understood from the examples below. The following examples are intended to illustrate the benefits of the present invention, but do not exemplify the full scope of the invention.

### EXAMPLE I

In order to evaluate the usefulness and durability of dry-erase coatings, a series of experiments were run in which various dry-erase coating formulations were produced, applied to a substrate and tested for writability, eraseability and durability. The components of one formulation, based on an alkyd resin, are illustrated in Table 1 below. Similarly, the components used to make a second formulation, based on an acrylic resin, are supplied in Table 2. For a third example, the flatting agents shown in Table 3 were added to the formulation of Table 1. Each of the listed flatting agents was used independently to make a different formulation.

TABLE 1
Coating 1

| | | PARTS BY |
|---|---|---|
| COMPONENT | TRADE NAME AND SOURCE | WEIGHT |
| Toluene | | 9.1 |
| Isobutyl alcohol | | 11.6 |
| Alkyl Resin | Chempol ® 804-4055 (Peninsula | 60.2 |
| | Polymers) | |
| Melamine Resin | Cymel ® 303 (Cytec Industries | 17.2 |
| | Inc.) | |
| Toluene Sulfonic Acid | Cycat ® 4040 Catalyst (Cytec | 1.9 |
| | Industries Inc.) | |

TABLE 2
Coating 2

| | | PARTS BY |
|---|---|---|
| COMPONENT | TRADE NAME AND SOURCE | WEIGHT |
| Toluene | Chemcentral | 13.7 |
| Isobutyl alcohol | Chemcentral | 13.7 |
| N-7 ethyl cellulose | Hercules Inc. | 0.6 |
| Acrylic Resin | Jonacyl ® 504 (Johnson Polymer) | 50.4 |
| Melamine Resin | Resimene ® 730 (Solutia Inc.) | 18.7 |
| Flow Control Agent | Modaflow ® 2100 (Solutia Inc.) | 0.6 |
| Toluene Sulfonic Acid | Cycat ® 4040 Catalyst (Cytec | 2.3 |
| | Industries Inc.) | |

TABLE 3
Coating 3

| | | PARTS BY |
|---|---|---|
| COMPONENT | TRADE NAME AND SOURCE | WEIGHT |
| Amorphous Precipitated | Syloid ® 169 (Grace Davison) | 0.7 |
| Silica | | |
| Amorphous Precipitated | Acematt ® OK 412 (Degussa) | 0.7 |
| Silica | | |

Each of the components listed in each table was mixed into a solution with a mechanical mixer at room temperature until uniformly dissolved or dispersed. The catalyst was added last, just prior to forming the coating. The coating formulations were coated on either paper or 2-4 mil polyester that had been chemically treated to promote adhesion. The coating was applied at a rate of about 2-6 pounds/3MSF. Each of the coatings was cured at a temperature of about 450° F. for a period of 15-20 seconds. The coatings were then evaluated for writability, eraseability and durability.

To test the chemical-resistance of each of the coatings, a cloth dipped in methyl ethyl ketone (MEK) was double rubbed 200 times with moderate pressure at the same location on the surface of the dry-erase coating. Each of Coatings 1, 2 and 3 passed a 200 MEK double rub test showing no signs of degradation. This indicates the coatings can provide a durable, resistant surface.

Each of the dry-erase coatings was also evaluated for its ability to be efficiently and completely erased after receiving an image for a sustained time. In a first test, writings from a variety of dry/erase markers from manufacturers such as Sanford, Ghent and Dixon Ticonderoga, were applied to each of the surfaces and allowed to age at ambient temperature for three months. After this time period, each of the dry/erase ink samples was dry-erased easily, with a paper towel, and left no stain or ghost image.

In an accelerated test, the Sanford marker inks were applied to Coatings 1, 2 and 3 and aged at 158° F. for a period of 24 hours. Although some of the images were more difficult to remove, the inks were completely erasable and no staining or ghosting resulted.

Coatings were tested under a variety of aging conditions using a commercially available erasable marker (Sanford Expo) and a reduced-solvent type erasable marker (Sanford Expo 2). Coatings 1, 2 and 3 were compared to polyester film and treated polyester film and were evaluated for ease of ink removal as well as resistance to staining. Results are provided below in Table 4. Ink removal was rated “easy” if it was removed from the surface after one or two wipes with a dry eraser. A rating of “moderate” means that the ink was removed after more than two wipes, but without added pressure. A rating of “difficult” means that multiple wipes at higher pressure (and effort) were required to remove the ink. The results show that the coatings tested provide good surfaces for use with commercially available markers, and in particular provide for easy removal of “Expo®” type marker ink, even after extensive aging.

TABLE 4
Ease of Ink Removal

| | | | Sanford Expo2 ® |
|---|---|---|---|
| Coating or Surface | Age condition | Sanford Expo ® | Low VOCs |
| Coating 1 | 2 weeks at room temp. | Easy | Easy |
| Coating 2 | 24 hrs. at 158° F. | Easy | Moderate |
| Coating 3 | 16 hrs. at 158° F. | Easy | Moderate to difficult |
| Untreated polyester | 3 days at room | Moderate | Moderate |
| film | temperature | | |
| Untreated polyester | 8 hrs. at 158° F. | Difficult, stained | Moderate |
| film | | | |
| Acrylic treated polyester, | 3 days at room | Moderate, | Easy |
| ex. SH-82 | temperature | stained | |
| Acrylic treated polyester | 8 hrs. at 158° F. | Difficult, stained | Easy |
| ex. SH-82 | | | |

### EXAMPLE 2

Different adhesives were evaluated to determine suitability for both adhesion to a variety of surfaces and removability without damaging the surface. A test was considered successful if an adhesive could effectively adhere the dry-erase sheet to a surface and remain affixed to the surface when written upon with a dry-erase marker and when erased with a dry eraser. The dry-erase sheets were also evaluated for removability on the basis of whether or not the sheet could be removed from a surface without leaving a residue and without damaging the coating.

Each of the adhesives listed in Table 5 was applied to a polyester film directly by Mayer rod and dried in an oven at 250° F. for 45 seconds. The adhesives were coated directly onto 3 mil. polyester film, and, after curing, the adhesive coated film was affixed to a flat stainless steel panel.

TABLE 5

| Adhesive Type | Designation | Tradename | Source |
|---|---|---|---|
| Acrylic emulsion | A | Micronax | Franklin International |
| with microspheres | | 240-01 | |
| Acrylic emulsion | B1 | APS 1313 | Ashland Specialty |
| with microspheres | B2 | APS 1374 | Polymers |
| Modified acrylic | C1 | GME 3084 | Solutia Inc. |
| emulsion with | C2 | GME 3088 | |
| microspheres | | | |
| Acrylic copolymer | D | JB461-115 | Franklin International |
| emulsion | | | |
| Vinyl acrylic | E | Covinax | Franklin International |
| copolymer emulsion | | 323-01 DEV | |

Coating parameters are provided in Table 6. Column 2 provides the coating weight at which the adhesive was applied to the polyester film and column 3 provides the force required to remove the film at a rate of 12 inches per minute at a 180° peel angle. A 30 minute dwell time was used prior to removal. Column 4 of Table 6 provides the same information as column 3, except for testing after a 24 hour dwell time.

TABLE 6

| | | Applied Force | |
|---|---|---|---|
| | | Lbs./in. 30 min | Applied Force |
| Adhesive | Lbs./3000 ft² | dwell | Lbs./in. 24 hr. dwell |
| A | 6.9 | 0.26 | 0.48 |
| A | 9.8 | 0.56 | 1.1 |
| B2 | 7.1 | 0.02 | 0.03 |
| B2 | 10.7 | 0.05 | 0.09 |
| C2 | 6.2 | 0.18 | 0.33 |
| C2 | 10.4 | 0.55 | 0.96 |
| D | 8.8 | 1.4 | 4.6-cohesive failure |
| D | 11.5 | 2.3 | 7.2-cohesive failure |
| E | 8.4 | 1.2 | 1.9 |
| E | 11.4 | 2.0 | 3.3 |

### EXAMPLE 3

The removability of each of the adhesives of Example 2 was evaluated on various surfaces and results are supplied in Table 7 below. A film coated with Adhesive A (acrylic emulsion microspheres) was easy to remove from a dry-erase board even after an adhesion time of 76 days. When placed on a rough textured vinyl wall cover, a polyester sheet coated with Adhesive D was easy to remove but adhesive A did not adhere well to the same wall covering. Thus, Adhesive A is more appropriate for fine textured surfaces while Adhesive D performs better on rough textured surfaces.

TABLE 7
Removal from Stainless Steel Surface

| | | Days | Ease of |
|---|---|---|---|
| Adhesive | Surface | Adhered | Removal |
| A | Dry-erase board | 76 | Easy |
| A | Glass | 47 | Easy |
| A | Latex painted wallboard | 47 | Very easy |
| A | Fine texture vinyl wallcover | 3 | Easy |
| A | Rough textured vinyl wallcover | 3 | Poor adhesion |
| D | Fine texture vinyl wallcover | 3 | More difficult |
| D | Rough textured vinyl wallcover | 3 | Easy |

### EXAMPLE 4

If an adhesive-backed dry-erase surface is to be supplied on a roll, it is important that the sheet can be unwound from the roll without excessive effort and without damaging the sheet. Various pairings of dry-erase coatings and removable adhesives were evaluated to determine the ease with which the roll could be unwound.

Samples of paper were coated with the dry-erase coatings of Tables 1 and 2 of Example 1 and were backside coated with different microsphere adhesives and wound onto a roll. Peel adhesion from the self-wound roll was then determined by peeling 90° at 300 inches per minute. The rolls were allowed to age for either 10 or 13 days prior to determining the tightness of unwind. Results are provided in Table 8. Requiring a force of 0.21 and 0.331 bs/in², with Adhesives A and B1 respectively, heat cured dry-erase coating 1 (alkyd resin) provided the easiest unwinding of the combinations tested and thus is well-suited for use with a self-wound roll. With the same adhesives, dry-erase coating 2 (acrylic resin) required a greater force for unwinding and thus is not as suitable as is dry-erase coating 1 for a self-wound roll. Ease of unwind also indicated no visible transfer of adhesive from the back of the paper to the dry-erase surface. This is important because a transfer of adhesive to the dry-erase surface can interfere with writing and erasing the surface.

TABLE 8
Wound Roll

| Dry-erase Coating | Adhesive | Dwell time, days | Lbs./2 in. |
|---|---|---|---|
| 1 | A | 13 | 0.21 |
| 1 | B1 | 13 | 0.33 |
| 2 | A | 13 | 2.1 |
| 2 | B1 | 13 | 0.75 |
| 1 | B2 | 10 | 0.43 |
| 2 | B2 | 10 | 0.73 |

While several embodiments of the invention have been described and illustrated herein, those of ordinary skill in the art will readily envision a variety of other means and structures for performing the functions and/or obtaining the results or advantages described herein, and each of such variations or modifications is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims (as well as in the specification above), all transitional phrases such as “comprising”, “including”, “carrying”, “having”, “containing”, “involving”, and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, section 2111.03.

What is claimed is:

1. A method of repairing a dry-erase surface comprising:
providing a sheet comprising two sides, a first side comprising a dry-erase material and a second side comprising an adhesive; and
adhering the sheet to the dry-erase surface.

2. The method of claim 1 wherein the sheet comprises paper.

3. The method of claim 1 wherein the sheet is opaque.

4. The method of claim 1 wherein the dry-erase board is discolored.

5. The method of claim 1 wherein the sheet comprises a color.

6. The method of claim 1 wherein the dry-erase surface comprises a white board.

7. The method of claim 1 wherein the second side is in contact with a removable backing.

8. The method of claim 7 wherein the removable backing comprises silicone.

9. A method of transforming a writing surface into a dry-erase surface comprising:
providing a sheet having at least two sides, a first side comprising a dry-erase surface having a surface tension greater than 30 dynes/cm and a second side comprising an adhesive; and
adhering the sheet to the writing surface.

10. The method of claim 9 comprising writing on the dry-erase surface.

11. The method of claim 10 comprising erasing the dry-erase surface.

12. The method of claim 9 wherein the writing surface comprises a chalkboard.

13. The method of claim 9 wherein the writing surface comprises paper.

14. The method of claim 9 wherein the adhesive is removable, repositionable or permanent.

15. The method of claim 14 wherein the adhesive is removable or repositionable.

16. The method of claim 9 wherein the sheet is tinted or colored.

17. A dry-erase surface comprising:
a substrate; and
a heat cured resin disposed on the substrate to form the dry-erase surface wherein the dry-erase surface exhibits a surface tension of greater than 30 dynes/cm.

18. The surface of claim 17 wherein the resin comprises a polymer selected from alkyds, polyesters and acrylics.

19. The surface of claim 17 wherein the surface tension is greater than about 30 dynes/cm.

20. The surface of claim 17 comprising:

21. A dry-erase surface comprising:
a substrate; and
a heat cured resin disposed on a portion of the substrate to form the dry-erase surface wherein the surface exhibits a 60° gloss of less than about 90 gloss units.

22. The surface of claim 21 wherein the 60° gloss is less than about 70 gloss units.

23. The surface of claim 21 wherein the 60° gloss is less than about 60 gloss units.

24. The surface of claim 21 wherein the surface exhibits a surface tension of greater than 30 dynes/cm.

25. The surface of claim 21 wherein the resin comprises a polymer selected from alkyds, polyesters and acrylics.

26. An article comprising:
a plurality of sheets stacked substantially overlapped with one another;
each of at least two of the sheets comprising a first surface and a second surface, wherein the first surface comprises a dry-erase surface and the second surface comprises a removable adhesive; and
wherein the second surface of a first sheet is in contact with the first surface of a second sheet.

27. The article of claim 26 wherein the first surface of at least one of the plurality of sheets exhibits a 60° gloss of less than 90 gloss units.

28. The article of claim 26 wherein the first surface exhibits a surface tension of at least 30 dynes/cm.

29. The article of claim 26 wherein the first surface comprises a heat cured polymer selected from alkyd, polyester and acrylic.

30. A method comprising:
writing on a first sheet of a stack of a plurality of sheets, wherein each of the first sheet and a second sheet comprises a first surface and a second surface, the first surface comprising a dry-erase coating and the second surface comprising a removable adhesive;
removing the first sheet from the stack;
adhering the first sheet to a substrate; and
writing on the second sheet.

31. The method of claim 30 wherein the step of writing on the first sheet precedes removing the first sheet from the stack.

32. The method of claim 30 comprising:
erasing substantially all of the writing from the first sheet;
removing the sheet from the substrate; and
adhering the first sheet to the stack.

33. The method of claim 30 wherein the first sheet is substantially transparent.

34. The method of claim 30 wherein the first surface exhibits a 60° gloss of less than 90 gloss units.

35. A kit comprising:
a first dry-erase surface comprising a dry-erase coating disposed on a substrate; and
instructions for affixing the first dry-erase surface to a second dry-erase surface.

36. The kit of claim 35 wherein an adhesive is disposed on the substrate.

37. The kit of claim 35 wherein the first dry-erase surface is flexible.

38. The kit of claim 35 wherein the first dry-erase surface is wound in a roll.

39. The kit of claim 35 wherein the first dry-erase surface exhibits a surface tension of greater than about 30 dynes/cm.

40. The kit of claim 35 wherein the dry-erase surface comprises a color.

41. The kit of claim 36 wherein a removable backing is in contact with the adhesive.

42. The kit of claim 41 wherein the removable backing comprises silicone-coated paper.
